(19) United States
(12) Patent Application Publication
(10) Pub. No.: US 2008/0017662 A1
(43) Pub. Date: Jan. 24, 2008

(54) Dispensing system for dispensing individual portions of a food product from a food product container

(76) Inventor: Linda S. Loranger, Chicago, IL (US)

Correspondence Address: Steven W. Weinrieb;Schwartz & Weinrieb, Crystal Plaza One, Suite 1109, 2001 Jefferson Davis Highway, Arlington, VA, 22202, US

(21) Appl. No.: 11/488,034

(22) Filed: Jul. 18, 2006

(51) Int. Cl. G07F 11/16

(52) U.S. Cl. 221/226

(57) ABSTRACT

A new and improved food product dispensing mechanism incorporates structure therewithin for enabling one to serially dispense individual portions of food products from a predetermined number of food product portions which are disposed in a stacked array or arrangement contained within a food product container. The structure comprises complementary members defined upon inner peripheral wall surface portions of the food product container and upon the piston member movably disposed within the food product container so as to pre-determinedly define stepwise movements of the piston member with respect to the food product container.

### FIELD OF THE INVENTION

The present invention relates generally to food product dispensing mechanisms, device, or systems, and more particularly to a new and improved food product dispensing mechanism, device, or system which incorporates therein means for enabling one to serially dispense, expel, or discharge individual portions of food products from a predetermined number or plurality of food product portions which are disposed within a stacked array or arrangement contained within a food product container.

### BACKGROUND OF THE INVENTION

Various different types of dispensing mechanisms, devices, or systems, for discharging, expelling, or dispensing, for example, various different types of food products, from various different types of food product containers, are of course well-known. Conventional, well-known dispensing mechanisms, devices, or systems of the aforenoted type are disclosed, for example, within U.S. Pat. No. 5,111,973 which issued to Mueller on May 12, 1992, U.S. Pat. No. 3,595,449 which issued to Stump et al. on Jul. 27, 1971, U.S. Pat. No. 3,481,458 which issued to Mayeaux on Dec. 2, 1969, U.S. Pat. No. 3,417,862 which issued to Fong on Dec. 24, 1968, U.S. Pat. No. 3,342,609 which issued to Bank et al. on Sep. 19, 1967, U.S. Pat. No. 3,070,224 which issued to Robinson et al. on Dec. 25, 1962, U.S. Pat. No. 2,166,619 which issued to Becker on Jul. 18, 1939, and U.S. Pat. No. 1,668,960 which issued to Grimmeisen on May 8, 1928.

It will be noted that all of the aforenoted patents disclose dispensing mechanisms, devices, or systems for dispensing, expelling, or discharging their various different food products, wherein, for example, the food products comprise a single homogeneous food product from which various different indeterminately sized amounts or portions of the food product are dispensed, expelled, or discharged. More particularly, the various different aforenoted patents all disclose various different mechanisms, devices, or systems which are used in connection with the dispensing, expelling, or discharging of semisolid or solid materials, such as, for example, ice cream or sherbert, sandwiches, cheese, or the like. The various different mechanisms, devices, or systems are generally similar to each other in that the same comprise, for example, a cylindrical container within which the particular food product is contained, and a plunger-type piston which is movably disposed internally within the cylindrical container. Accordingly, when a portion of the food product is to be dispensed, expelled, or discharged from the cylindrical container, the piston is moved upwardly within the cylindrical container so as to effectively dispense, expel, or discharge some indeterminately sized amount or portion of the food product therefrom.

It is therefore to be noted that while the aforenoted various different mechanisms, devices, or systems are generally satisfactory in connection with the desired dispensing, expulsion, or discharge of the various different indeterminately sized portions of the single homogeneous food product from the overall food product disposed and contained within the food container, none of the aforenoted various different mechanisms, devices, or systems is capable of dispensing, expelling, or discharging specific, predeterminedly sized, individual, discrete portions of the food product out from the food container. More particularly, none of the aforenoted various different mechanisms, devices, or systems contains or incorporates means therein which enables or facilitates the dispensing, expelling, or discharging of specific, predeterminedly sized, individual, discrete portions of the food product out from the food container. Such a mode of operation is desirable, for example, when specific, predeterminedly sized, individual, discrete portions of the food product are intended to be served as a component part of a particular meal, or when, for example, specific, predeterminedly sized, individual, discrete portions of the food product are to be incorporated within a sandwich, or the like.

A need therefore exists in the art for a new and improved mechanism, device, or system, for use in connection with food product containers within which a plurality of food products are disposed in a stacked mode, array, or arrangement, wherein means can be integrally incorporated within the food product container which can enable or facilitate the dispensing, expulsion, or discharge of specific, predeterminedly sized, individual, discrete portions of the food product out from the food container.

### SUMMARY OF THE INVENTION

The foregoing and other objectives are achieved in accordance with the teachings and principles of the present invention through the provision of a new and improved mechanism, device, or system, for use in connection with food product containers within which a plurality of discrete, separate, individual food products are disposed in a stacked mode, array, or arrangement, wherein the new and improved mechanism, device, or system comprises a tubular cylindrical food product container which is open at both the lower and upper ends thereof and within which the plurality of discrete, separate, individual food products are disposed within a vertically stacked array or arrangement. More particularly, the discrete, separate, individual food products are preferably separated from each other by means of, for example, a piece or sheet of waxed paper, and are adapted to be disposed upon and supported by a piston member which is disposed within the tubular cylindrical product container for vertical reciprocal movements therewithin. The piston member is provided with a manually manipulable handle, and a plurality of vertically spaced, annular detents, ridges, or dimples are integrally incorporated upon the internal peripheral wall surface of the tubular cylindrical product container for engagement by the upper annular edge portion of the vertically movable piston member. Accordingly, when the discrete, separate, individual food products are to be individually but serially dispensed, expelled, or discharged from the food product container, the piston member, initially disposed at its lowermost position within the tubular cylindrical food product container at which the upper annular edge portion of the piston member will be engaged with the first or lowermost one of the plurality of vertically spaced, annular detents, ridges, or dimples, will be moved or pushed upwardly so as to effectively bypass or skip over the first or lowermost one of the plurality of vertically spaced, annular detents, ridges, or dimples and will subsequently encounter a second one of the plurality of vertically spaced, annular detents or dimples.

Accordingly, as a result of such a defined movement of the piston member within the tubular cylindrical food product container, a first one of the plurality of food products will be dispensed, expelled, or discharged from the food product container. Subsequently, when, for example, a second discrete, separate, or individual food product is to be dispensed, expelled, or discharged from the food product container, the piston member will again be moved or pushed upwardly whereby, for example, the upper annular edge portion of the piston member, having encountered the second one of the plurality of vertically spaced, annular detents or dimples, will now effectively bypass, skip, or ratchet over such second one of the plurality of vertically spaced, annular detents or dimples, and will continue such vertically upward movement until the upper annular edge portion of the piston member encounters the third one of the plurality of vertically spaced, annular detents, ridges, or dimples. Accordingly, as a result of such another defined movement of the piston member within the tubular cylindrical food product container, a second one of the plurality of food products will be dispensed, expelled, or discharged from the food product container. This process can of course be repeated until, for example, all of the discrete, separate, individual food products disposed within the food product container have been dispensed, expelled, or discharged from the food product container. It is to be noted that while the internal peripheral wall surface of the tubular cylindrical food product container can be provided with the aforenoted annular detents, ridges, or dimples to be encountered by means of the upper annular edge portion of the piston member, alternatively, the internal peripheral wall surface of the tubular cylindrical food product container can be provided with a plurality of vertically spaced annular notches or recesses and the upper end portion of the piston member can be provided with a radially outwardly projecting flange portion for disposition with the annular recessed portions defined within the internal peripheral wall surface of the tubular cylindrical food product container.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic cross-sectional view of a first embodiment of a new and improved food product dispensing mechanism, device, or system, constructed in accordance with the principles and teachings of the present invention, wherein the same incorporates therein first means for enabling one to serially dispense, expel, or discharge discrete, separate, individual portions of food products from a predetermined number or plurality of food product portions which are disposed within a stacked array or arrangement contained within a food product container, and wherein the piston member is disposed at its lowermost START position within the tubular cylindrical food product container;

FIG. 2 is a cross-sectional view similar to that of FIG. 1, showing, however, the piston member disposed at an intermediate vertical position after having dispensed, expelled, or discharged several of the discrete, separate, individual portions of the food products from the tubular cylindrical food product container;

FIG. 3 is a cross-sectional view of the first embodiment food product container constructed in accordance with the principles and teachings of the present invention and showing the cooperative parts thereof as also disclosed within FIGS. 1 and 2;

FIG. 4a is a cross-sectional view of a second embodiment food product container constructed in accordance with the principles and teachings of the present invention and showing the cooperative parts thereof; and

FIG. 4b is a cross-sectional view of a second embodiment piston member for use within the second embodiment food product container as disclosed within FIG. 4a.

### DETAILED DESCRIPTION OF THE PREFERRED EMBODIMENT

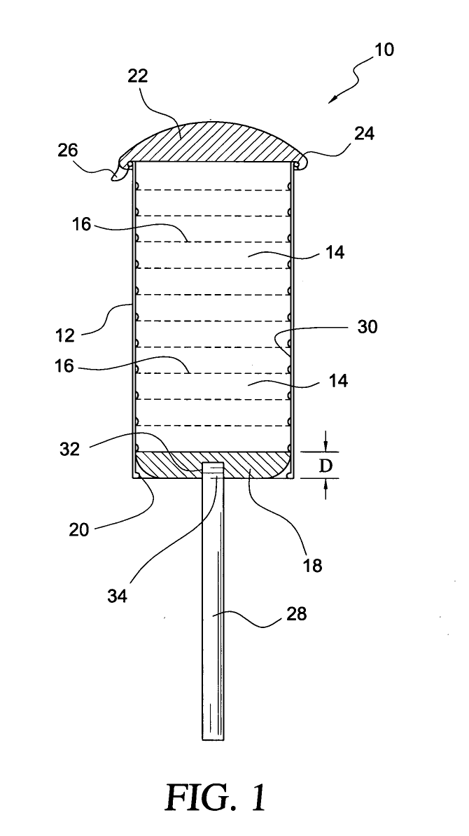

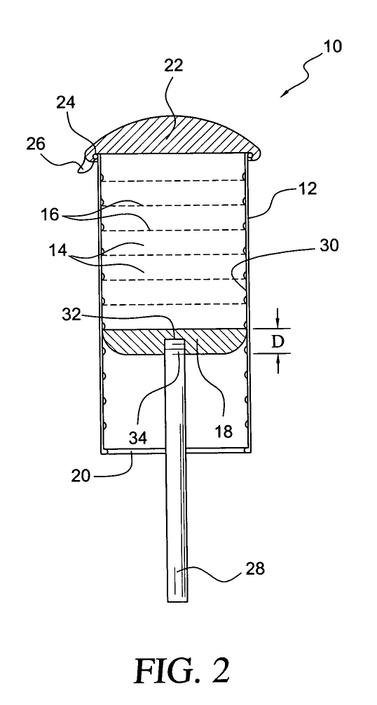

Referring now to the drawings, and more particularly to FIGS. 1 and 2 thereof, a new and improved food product dispensing mechanism, device, or system, constructed in accordance with the principles and teachings of the present invention, is disclosed and is generally indicated by the reference character 10. More particularly, it is seen that the new and improved food product dispensing mechanism, device, or system 10 comprises a tubular cylindrical food product container 12 which is adapted to hold a predetermined number or plurality of discrete, individual food product portions 14 which are disposed within the tubular cylindrical food product container 12 in a vertically stacked array or arrangement. Individual pieces of, for example, waxed paper 16, are interposed between successive ones of the plurality of vertically stacked food product portions 14, so as to not only physically separate the discrete, individual food product portions 14 from each other, but in addition, in order to facilitate, for example, the separation of the uppermost one of the plurality of vertically stacked food product portions 14 from the remaining food product portions 14 still disposed or remaining within the tubular cylindrical food product container 12 when the uppermost one of the plurality of vertically stacked food product portions 14 has been dispensed out from the food product container 12. The tubular cylindrical food product container 12 is open at both the upper and lower end portions thereof, and a piston member 18 is adapted to be disposed internally within the tubular cylindrical food product container 12 so as to be capable of undergoing vertical reciprocal movements. The lower, open end portion of the tubular cylindrical food product container 12 is provided with a radially inwardly projecting annular lip or flange portion 20 in order to effectively prevent the piston member 18 from becoming inadvertently removed, or effectively falling out, from the open lower end portion of the tubular cylindrical food product container 12, and a suitable cover or lid member 22 is disposed upon the upper end portion of the tubular cylindrical food product container 12 so as to effectively close the upper end portion of the tubular cylindrical food product container 12 when the dispensing or discharging of one or more of the plurality of food product portions 14 out from the tubular cylindrical food product container 12 is not being performed. The upper end portion of the tubular cylindrical food product container 12 is provided with a radially outwardly projecting annular flange or lip portion 24 over or around which the cover or lid member 22 is adapted to be fitted in a substantially snap-on/snap-off manner, and a suitably configured finger grip member 26 is integrally formed upon, for example, a single peripheral region of the cover or lid member 22 so as to facilitate the removal of the cover or lid member 22 from the upper end portion of the tubular cylindrical food product container 12.

Continuing further, it is seen that a manually manipulable handle 28 is adapted to be fixedly mounted within the external undersurface portion of the piston member 18 in order to readily facilitate the vertical reciprocal movements of the piston member 18 within, and with respect to, the inner peripheral wall surface 30 of the tubular cylindrical food product container 12. More particularly, in order to fixedly secure the manually manipulable handle 28 within the piston member 18, it is seen that the external undersurface portion of the piston member 18 is provided with an internally threaded blind bore 32 and that the upper end portion of the manually manipulable handle 28 is externally threaded as at 34. Accordingly, when, for example, the new and improved food product dispensing mechanism, device, or system 10 of the present invention is in fact to be utilized in connection with the dispensing, expelling, or discharging of one or more discrete, separated, and individual food product portions 14, the manually manipulable handle 28 can be attached to the piston member 18 so as to facilitate the upward movements thereof, whereas when, for example, a food portion dispensing, expelling, or discharging operation is not to be performed, the manually manipulable handle 28 can be disengaged or removed from the piston member 18 so as to facilitate more compact storage of the overall food product dispensing mechanism, device, or system 10, such as, for example, within refrigerated storage facilities.

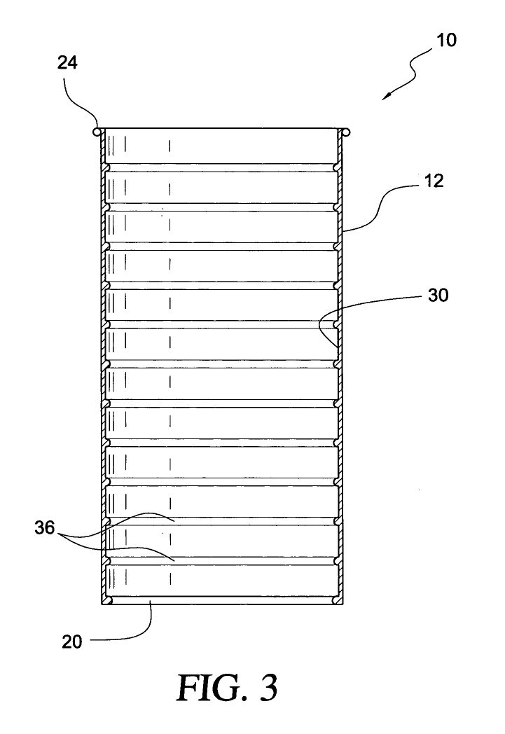

In order to in fact facilitate the dispensing, expelling, or discharging of one or more of the discrete, separated, individual food product portions 14 out from the tubular cylindrical food product container 12 in a successive or serial manner, it is also to be appreciated that in accordance with further teachings and principles of the present invention, the upper edge portion of the piston member 18 and the inner peripheral wall surface 30 of the tubular cylindrical food product container 12 can effectively be provided with interengaging or intercooperative male and female or complementary means such that the piston member 18 will be moved in a predeterminedly defined, substantially stepwise manner, which can be readily sensed in a tactile manner by means of the person operating the food product dispensing mechanism, device, or system 10 of the present invention, so as to effectively dispense, expel, or discharge only a single one of the food product portions 14 at any one time. More particularly, as can be appreciated, for example, from FIG. 3, the inner peripheral wall surface 30 of the tubular cylindrical food product container 12 is provided with a plurality of axially or vertically spaced, annular dimples, ridges, or detents 36 for engagement by the upper annular edge portion of the piston member 18.

In this manner, when, for example, a food product dispensing or discharging operation is to be performed with the food product container 12 filled with food product portions 14, the piston member 18 will be disposed at its lowermost position within the food product container 12 as disclosed within FIG. 1, wherein, for example, the undersurface annular portion of the piston member 18 will be substantially engaged with the radially inwardly projecting annular flange or lip portion 20 of the food product container 12 and will also, for example, be disposed beneath the lowermost one of the plurality of vertically spaced, annular detents, ridges, or dimples 36 such that the upper annular edge portion of the piston member 18 will be substantially disposed in contact with the lowermost one of the plurality of vertically spaced, annular detents, ridges, or dimples 36. This disposition of the piston member 18 defines the START position of the piston member 18 within the food product container 12 of the food product dispensing device, mechanism, or system 10 of the present invention in order to effectively ready the food product dispensing mechanism, device, or system 10 of the present invention for the commencement of a food product dispensing, expelling, or discharging operation.

Thereafter, the piston member 18 will be moved in the vertically upward direction, overcoming the slight resistance to such movement as presented by means of the first lowermost one of the vertically spaced, annular detents, ridges, or dimples 36, whereby, the piston member 18, having ratcheted over or bypassed the first lowermost one of the vertically spaced, annular detents, ridges, or dimples 36, will be moved vertically upwardly a predetermined amount until the upper annular edge portion of the piston member 18 encounters the second one of the vertically spaced annular detents, ridges, or dimples 36. This engagement or encountering of the second one of the vertically spaced annular detents, ridges, or dimples 36 can be sensed or felt in a tactile manner by the operator whereby further upward movement of the piston member 18 is effectively terminated if in fact only a single one of the food product portions 14 is to be dispensed, expelled, or discharged from the food product container 12. Accordingly, at this point in time, the uppermost one of the plurality of discrete, separated, individual food portions 14 disposed and supported upon the piston member 18, will have been dispensed, expelled, or discharged from the open upper end portion of the food product container 12. If additional ones of the discrete, separated, individual food products 14 are to be dispensed or discharged, the foregoing procedure may of course be repeated as necessary. FIG. 2 illustrates the state of the new and improved food product dispensing mechanism, device, or system 10 wherein several discrete, separate, individual food product portions have already been dispensed, expelled, or discharged from the food product container 12. It is to be noted, in connection with the structure of the piston member 18, that while the piston member 18 has been illustrated as having a substantially arcurate cross-sectional configuration, other cross-sectional configurations are of course possible. In addition, in connection with the serial movement of the piston member 18 with respect to the food product container 12, the vertical depth D of the piston member 18 is approximately the same as or slightly less than the vertical spacing defined between successive ones of the detents, ridges, or dimples 36 so as to permit the piston member 18 to bypass a particular one of the detents, ridges, or dimples 36, to be disposed within the next space which is defined between the bypassed ridge, detent, or dimple 36 and the next detent, ridge, or dimple 36 with which the piston member 18 will subsequently be engaged, and to thereby enable the user to feel or sense, in a tactile manner, the bypass and interengagement of the piston member 18 with respect to the particularly noted detents, ridges, or dimples 36.

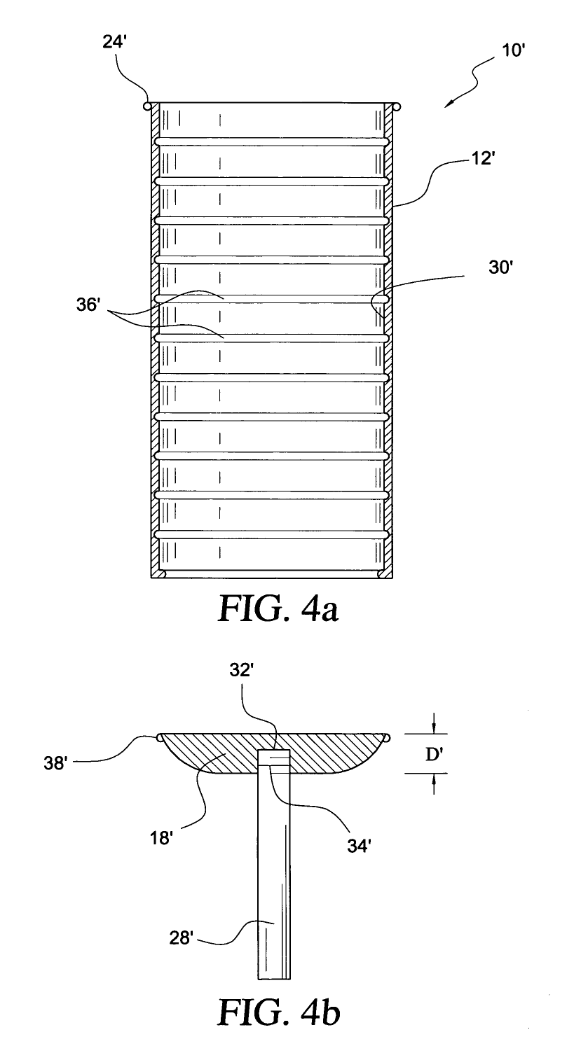

While it has been noted that in order to facilitate the dispensing, expelling, or discharging of one or more of the discrete, separated, individual food product portions 14 out from the tubular cylindrical food product container 12 in a successive or serial manner, the upper annular edge portion of the piston member 18 can serially interengage a plurality of vertically spaced annular detents, ridges, or dimples 36 disposed or formed upon the inner peripheral wall surface 30 of the tubular cylindrical food product container 12, alternative interengaging male and female means can likewise be provided upon the piston member and the inner peripheral wall surface of the food product container. More particularly, as can best be appreciated from FIG. 4a, and in accordance with the teachings and principles of a second embodiment of a new and improved food product dispensing mechanism, device, or system, which is generally indicated by means of the reference character 10′, in lieu of the male type detents, ridges, or dimples 36 formed upon the inner peripheral wall surface 30 of the food product container 12, as disclosed within FIG. 3, the inner peripheral wall surface 30′ of the food product container 12′ is provided with a plurality of vertically spaced, annular notches or recesses 36′ within which an annular, radially outwardly projecting flange portion 38′, formed upon the upper annular edge portion of the piston member 18, as can be seen within FIG. 4b, can be disposed.

Accordingly, the stepwise dispensing, expelling, or discharging of the plurality of discrete, separated, individual food products 14, out from the food product container 12′, can be achieved in a manner similar to that as has been described hereinbefore in connection with the first embodiment food product dispensing mechanism, device, or system 10 as has been disclosed within FIGS. 1-3. It is lastly noted that in connection with either one of the food product containers 12,12′, the same may be fabricated from a suitable thermoplastic, paper, or cardboard material, and in the latter cases, that is, when fabricated from a suitable paper or cardboard product, the inner peripheral wall surfaces 30, 30′ thereof may have a suitable layer or coating of wax material disposed thereon in order to easily facilitate the vertically reciprocal movement of the piston members 18,18′ therealong.

Thus, it may be seen that in accordance with the principles and teachings of the present invention, there has been disclosed a new and improved a new and improved mechanism, device, or system, for use in connection with food product containers within which a plurality of discrete, separate, individual food product portions are disposed in a stacked mode, array, or arrangement, wherein the new and improved mechanism, device, or system comprises means for enabling the serial or successive dispensing, expelling, or discharging of the discrete, separate, individual food product portions in a stepwise, one-at-a-time manner by means of a piston member movably disposed within a cylindrical food product container. The means for enabling such a dispensing, expelling, or discharging mode of operation comprises male and female means which are respectively incorporated upon the piston member and the food product container. In particular, such means may comprise a plurality of vertically spaced annular detents, ridges, or dimples integrally incorporated upon the inner peripheral wall surface of the food product container for engagement by the upper annular peripheral edge portion of the piston member, or alternatively, a plurality of vertically spaced notches or recesses defined within the inner peripheral wall surface of the food product container within which a radially outwardly projecting flange member of the piston member can be disposed in a stepwise manner. In either case, the user or operator can sense the stepwise movement of the piston member within the tubular cylindrical food product container, in a tactile manner, in connection with the individual dispensing, expelling, or discharging of the food products out from the food product container.

Obviously, many variations and modifications of the present invention are possible in light of the above teachings. For example, it is to be noted that the depth or thickness dimension of the piston member, and the vertical spacing or distance defined between successive ones of the plurality of detents, ridges, dimples, or recesses defined upon the inner peripheral wall surface of the tubular cylindrical food product container, effectively defining the extent of the vertical stepwise travel of the piston member, may be varied in accordance with the vertical depth or thickness dimension of the particular food product to be dispensed, expelled, or discharged in order to ensure that for each stepwise movement of the piston member with respect to the inner peripheral wall surface of the food product container, only one individual food product portion is dispensed, expelled, or discharged at any one time. It is therefore to be understood that within the scope of the appended claims, the present invention may be practiced otherwise than as specifically described herein.

What is claimed as new and desired to be protected by Letters Patent of the United States of America is:

1. A mechanism for facilitating the dispensing of individual products, one at a time, from a plurality of products serially disposed within a product container, comprising:
a product container within which a plurality of products are adapted to be disposed in a serial array, said product container having an inner peripheral wall surface and an open end through which the plurality of products are to be dispensed;
a piston member, adapted to be disposed in contact with an end one of the plurality of products disposed within said product container, and disposed within said product container for movement along said inner peripheral wall surface of said product container toward said open end of said product container; and
means defined upon said product container and said piston member for defining predetermined stepwise movements of said piston member with respect to said product container as said piston member is moved within said product container toward said open end of said product container so as to permit said piston member to individually dispense the plurality of products, disposed within said product container, out from said product container one at a time.

2. The mechanism as set forth in claim 1, wherein:
said product container comprises a tubular cylinder; and
said piston has a substantially cylindrical cross-sectional configuration.

3. The mechanism as set forth in claim 2, wherein:
said means defined upon said product container and said piston member for defining predetermined stepwise movements of said piston member with respect to said product container as said piston member is moved within said product container toward said open end of said product container comprises first and second complementary means.

4. The mechanism as set forth in claim 3, wherein:
said first complementary means defined upon said product container comprises a plurality of axially spaced members defined upon inner peripheral wall surface portions of said product container, and said second complementary means defined upon said piston member comprises an annular edge portion of said piston member for engaging each one of said plurality of axially spaced members defined upon said inner peripheral wall surface portions of said product container.

5. The mechanism as set forth in claim 4, wherein:
said plurality of axially spaced members defined upon said inner peripheral wall surface portions of said product container are selected from the group comprising annular detents, ridges, and dimples.

6. The mechanism as set forth in claim 3, wherein:
said first complementary means defined upon said product container comprises a plurality of axially spaced members defined upon inner peripheral wall surface portions of said product container, and said second complementary means defined upon said piston member comprises an annular flanged portion of said piston member for engaging each one of said plurality of axially spaced members defined upon said inner peripheral wall surface portions of said product container.

7. The mechanism as set forth in claim 6, wherein:
said plurality of axially spaced members defined upon said inner peripheral wall surface portions of said product container are selected from the group comprising annular recesses and notches.

8. The mechanism as set forth in claim 1, wherein:
said product container may be fabricated from a material selected from the group comprising paper, cardboard, and thermoplastics.

9. The mechanism as set forth in claim 1, wherein:
said inner peripheral wall surface of said product container has a wax coating thereon so as to facilitate the movement of said piston member therealong.

10. A mechanism for facilitating the dispensing of individual products, one at a time, from a plurality of food products serially disposed within a food product container, comprising:
a food product container within which a plurality of food products are adapted to be disposed in a serial array, said food product container having an inner peripheral wall surface and an open end through which the plurality of food products are to be dispensed;
a piston member, adapted to be disposed in contact with an end one of the plurality of food products disposed within said food product container, and disposed within said food product container for movement along said inner peripheral wall surface of said food product container toward said open end of said food product container; and
means defined upon said food product container and said piston member for defining predetermined stepwise movements of said piston member with respect to said food product container as said piston member is moved within said food product container toward said open end of said food product container so as to permit said piston member to individually dispense the plurality of food products, disposed within said food product container, out from said food product container one at a time.

11. The mechanism as set forth in claim 10, wherein:
said food product container comprises a tubular cylinder; and
said piston has a substantially cylindrical cross-sectional configuration.

12. The mechanism as set forth in claim 11, wherein:
said means defined upon said food product container and said piston member for defining predetermined stepwise movements of said piston member with respect to said food product container as said piston member is moved within said food product container toward said open end of said food product container comprises first and second complementary means.

13. The mechanism as set forth in claim 12, wherein:
said first complementary means defined upon said food product container comprises a plurality of axially spaced members defined upon inner peripheral wall surface portions of said food product container, and said second complementary means defined upon said piston member comprises an annular edge portion of said piston member for engaging each one of said plurality of axially spaced members defined upon said inner peripheral wall surface portions of said food product container.

14. The mechanism as set forth in claim 13, wherein:
said plurality of axially spaced members defined upon said inner peripheral wall surface portions of said food product container are selected from the group comprising annular detents, ridges, and dimples.

15. The mechanism as set forth in claim 12, wherein:
said first complementary means defined upon said food product container comprises a plurality of axially spaced members defined upon inner peripheral wall surface portions of said food product container, and said second complementary means defined upon said piston member comprises an annular flanged portion of said piston member for engaging each one of said plurality of axially spaced members defined upon said inner peripheral wall surface portions of said food product container.

16. The mechanism as set forth in claim 6, wherein:
said plurality of axially spaced members defined upon said inner peripheral wall surface portions of said food product container are selected from the group comprising annular recesses and notches.

17. The mechanism as set forth in claim 10, wherein:
said food product container may be fabricated from a material selected from the group comprising paper, cardboard, and thermoplastics.

18. The mechanism as set forth in claim 10, wherein:
said inner peripheral wall surface of said food product container has a wax coating thereon so as to facilitate the movement of said piston member therealong.

19. The mechanism as set forth in claim 10, further comprising:
means for separating the plurality of food products, disposed within said food product container, from each other so as to facilitate the separation of the dispensed food product from the plurality of food products remaining within said food product container.

20. The mechanism as set forth in claim 19, wherein:
said means for separating the plurality of food products, disposed within said food product container, from each other comprises sheets of paper adapted to be interposed between successive ones of the plurality of food products disposed within said food product container.
